(19) United States
(12) Patent Application Publication
(10) Pub. No.: US 2010/0079982 A1
(43) Pub. Date: Apr. 1, 2010

(54) Inspection Probes and Methods of Use

(76) Inventor: Michael E. Aceves, Coarsegold, CA (US)

Correspondence Address: MARK D MILLER;KIMBLE, MACMICHAEL & UPTON, 5260 NORTH PALM AVENUE, SUITE 221, FRESNO, CA, 93704, US

(21) Appl. No.: 12/570,597

(22) Filed: Sep. 30, 2009

Related U.S. Application Data
(60) Provisional application No. 61/194,975, filed on Oct. 1, 2008.

(51) Int. Cl. B25B 23/16

(52) U.S. Cl. 362/119

(57) ABSTRACT

The present invention discloses devices and methods that facilitate the safe and efficient manipulation and illumination of objects. More specifically, the present invention discloses devices and methods for non-invasive inspection of the clothing, pockets, purses, backpacks and other personal items of individuals apprehended and/or held by law enforcement, military or emergency medical personnel. The present invention facilitates safe visual inspection of hiding places such as pockets, gaps between seat cushions, and the like, in order to avoid needle pricks or other injury during such inspections. Embodiments of the invention include a rigid, flat-handled lighted adjustable probe for insertion into such spaces to pry or open them for visual inspection.

This application claims the benefit of U.S. Provisional Patent Application No. 61/194,975 filed on Oct. 1, 2008, which is incorporated herein by this reference in its entirety.

### BACKGROUND OF THE INVENTION

1. Field of the Invention

The present invention relates to methods and apparatus for facilitating safe and efficient visual inspection and illumination of hiding places such as pockets, purses, gaps between seat cushions, and the like, in order to avoid needle pricks or other injury during such inspections. More particularly the present invention discloses devices and methods for safe, non-invasive visual inspection of the clothing, pockets, personal items, vehicles and furniture of individuals apprehended and/or held by law enforcement, military or medical personnel.

2. Description of the Prior Art

When apprehending and/or holding detainees, it is generally necessary to determine if such detainees have possession or access to items or substances that can assist the detainee in escape, that pose a threat to the individual(s) apprehending or holding the detainee, or that can be smuggled into secure areas. Every person who is placed under arrest (or similar custody) or otherwise comes under the care or supervision of a law enforcement or corrections officer should be subject to a complete, systematic and thorough search. The failure to conduct such searches can result in numerous negative consequences, including injury to the detaining officer, the detainee and/or third parties.

Recently, searches have come under scrutiny with the increasing awareness of the threat of communicable diseases, including HIV (AIDS) and Hepatitis. The incurable and fatal nature of such diseases have created an increasing need to avoid direct contact with bodily fluids of the detainees who, in the case of intravenous drug users, may have drug paraphernalia (including hypodermic needles) in their possession which may injure or infect an officer conducting a manual (hand/finger) search of areas such as pockets or purses.

U.S. Pat. No. 6,099,138 discloses a search probe made up of a flexible bendable blade attached to a flashlight for insertion into an area such as a pocket to detect objects therein that happen to come into contact with the blade. The flashlight in this device is of little assistance since the blade is not capable of opening the pocket very much at all, requiring the inspecting officer to ultimately insert a finger or hand into the area to be searched thereby defeating the prophylactic purpose of the probe.

A need exists, therefore, for non- or minimally-invasive methods and apparatus for searching the pockets, possessions and vicinity of a detainee without requiring initial direct physical contact by the hands and/or other body parts of the person performing the inspection.

### SUMMARY OF THE INVENTION

The present invention includes devices and methods that allow a law enforcement officer or other inspection personnel to visualize the contents of the clothing, possessions and/or vicinity of a detainee prior to conducting a hand search of the detainee. Desirably, the methods and devices disclosed herein allow the inspector to determine whether a dangerous or hazardous item is contained within the target area, and thereby avoid contacting such items, while also allowing a thorough and complete search of the detainee.

In some embodiments, the device comprises an L-shaped “paddle” with a handgrip at one end and a light source and manipulator arm at the other end. Desirably, the L-shape allows the officer to grasp the device an a manner similar to a single-handed weapon (i.e. a pistol), allowing the officer to manipulate the device with a single hand while using the opposite hand to control the detainee (i.e., holding the detainee's hands together or grasping one or more arms or handcuffs—if handcuffs are utilized—to hold the detainee's arms together behind their back).

In these embodiments, the manipulator arm of the device may be inserted into the pockets, purse or personal items of the detainee, then twisted as much as 90 degrees, to distend the pocket and allow the light to illuminate the contents of the pocket. In some embodiments, one or more lights may be used illuminate both sides of the manipulator (and thus will illuminate both sides of the pocket) thus illuminating the entirety of the pocket and allowing the inspector to look into the opened pocket. In addition, the light could be of sufficient intensity to allow visualization of the pocket contents through the fabric of the clothing, allowing the officer to directly visualize the contents of the pockets while maintaining a safe distance from the detainee's hands, mouth and/or other bodily orifices.

Embodiments of the invention allow the inspector's hands to remain outside of the pockets and/or clothing of the detainee, in the event items such as knives, razor blades, needles, etc. are within such areas. In addition, the use of such devices allows officers of opposing gender to the detainee to safely search the detainee without direct physical contact, desirably avoiding potential sexual misconduct claims from detainees of the opposing sex.

In some embodiments, the device may comprise one or more light sources of forty to eighty lumens, although other illumination levels (including 100 or 200 lumens or multiple setting of illumination) could alternatively be utilized. Desirably the light source includes at least one light that illuminates both sides of the manipulator arm, or could include two or more lights (i.e., one or more on each side of the arm), as desired. Power for the light may be provided by virtually any power source, including rechargeable or disposable batteries. In one embodiment, the power source comprises a single AAA battery (1.5V).

Aside from direct visualization, embodiments of the present invention further allow an inspector to identify hidden objects through direct contact between the object and the device. Depending upon the material the device is made from, and the composition of the object, the inspector can receive physical (through the handle of the device) and/or aural (i.e., tapping or metallic/ceramic “clinking” sound) indications of the presence or absence of objects. In addition, the device could be used to pry or otherwise open small spaces (i.e., cracks between cushions in car seats or furniture, inside backpack crevices and/or along frame members), allowing visualization therein. In addition, the flattened shape of the manipulator arm (in various embodiments) could indicate that an individual's pockets contained an item of interest if the pocket surface was irregular subsequent to insertion of the arm (i.e., objects protruding out from the arm may distend the surface of the pocket).

In addition to facilitating the search of a detainee, the device could be utilized as a “weapon of last resort” in emergency circumstances. Moreover, the device could be utilized as-is as an illumination device (i.e., a flashlight), or could incorporate intensity and/or focusing settings to facilitate further uses, depending upon need. In various embodiments, the device may “dock” or otherwise attach to a weapon to assist in aiming the weapon and/or facilitating use of the weapon in low-level lighting situations.

It should be understood that the devices and methods disclosed herein have numerous applications outside of the specific areas disclosed. For example, these devices and methods are useful to individuals manipulating objects in an insufficiently-lighted area, or those seeking to pry, twist, shift or otherwise move objects. In addition, the devices and methods disclosed herein may be useful for local, state and federal law enforcement agencies, coroner and/or medical examiners, military and/or federal security forces, homeland security and/or immigration, private security, EMS and/or hospital workers, or the like.

In use, an inspector identifies an area for search such as a pocket on a garment or backpack, or a gap between the seat cushions of an automobile. The flat panel of a probe of the present invention is inserted into the pocket or gap, so that the panel is generally parallel to the length of the pocket/gap. Using the handle attached to the panel, the inspector then turns the inserted panel so that it is no longer parallel with the length of the pocket/gap. This turn or twist may move the panel as much as 90 degrees, which pries open the pocket or gap, exposing the interior. The light may then be activated, if necessary, to illuminate both sides of the panel, thereby illuminating the interior of the pocket or gap that has been pried open. This allows a visual inspection of this area without the inspector having to insert a finger or hand, which might otherwise result in a cut or needle prick. Once the objects in the search area have been identified, the inspector may then decide whether or not to insert a hand or finger into the search area to retrieve them. It is to be appreciated that an inspection may be accomplished using the methods and devices of the present invention with one hand, leaving the inspector's other hand available to restrain the detainee, operate a radio, or other activity.

It is to be appreciated that for an inspection of, for example, the gap along the entire back seat of an automobile, a device of the present invention may be inserted and twisted at several locations along such a gap. Similarly, for an article of clothing including multiple pockets, flaps or slots, a device of the present invention may be inserted and then twisted in each of them in a series of multiple separate inspections.

It is to be appreciated that the panels of the present invention must be made of a rigid material such as metal, hardwood, or rigid plastic in order to carry out the prying function caused by the twisting of the panel once inserted into a tight gap. It is also to be appreciated that the panels of the present invention must be generally flat, having a thin side profile to easily slip into a thin gap such as a pocket, but must also have a wide front and rear surface in order to pry such a gap open when twisted. In different embodiments of the present invention, the panels may be elongated in order to fit into deep pockets or distant gaps, and/or the panels may be extra wide in order to be able to sufficiently open wider gaps for visual inspection, and/or extra thin in order not to tear open a pocket or other gap.

In some embodiments, the width and/or length of the panel may be adjustable so that it may be sized by the inspector to fit into a particular pocket or gap to be inspected. For example, and without limitation, a handle of the present invention may support a plurality of adjacent flat panels that are slidable along one or more tracks in the handle. The total width of these adjacent panels may be adjusted by sliding them relative to one another, and once an acceptable width is reached, they may be locked into place for use by the inspector. In other embodiments, one or more extensions may be temporarily attached to the panel to extend its length and/or width. These extensions may be easily detached to return the panel to its original size. In some embodiments, a plurality of panels may be telescopingly provided, with a base panel of this plurality attached to the handle, so that the total panel length may be suitably adjusted for insertion into a shallow or deep recess. It is to be appreciated that different embodiments of the invention may include different combinations of one or more of these adjustability features, for adjustment of both width and/or length of the insertion panel.

In most embodiments, a handle is attached to the panel in an angled configuration in order to allow for easy manipulation (insertion/twisting) of the attached panel by the user. In some embodiments, the handle is attached in a generally perpendicular orientation with respect to the panel, sometimes forming an “L” shape. However, for space saving reasons, panels of the present invention may be provided without a handle. It is to be appreciated that any corners of the panel are preferably rounded in order to avoid snarling or entanglement when in use.

In most embodiments, a light source is provided to illuminate both sides of the panel; however, in other embodiments only one side of the panel may be illuminated. A single light source may be used to illuminate both sides of the panel, or separate light sources may be provided, one on each side. Each light source may be independently operable. In some embodiments, one or more LEDs may be used. In some embodiments, a simple thumb switch may be used to activate/deactivate the light source(s).

In some embodiments, one or both sides of the panel(s) may be provided with reflective or mirrored surfaces. These surfaces aid visual inspection by reflecting light into the inspection area, and by allowing an inspector to have additional angles for visual inspection. In other embodiments, one or both of the panels may be provided with light colored surfaces to more readily illuminate the area for visual inspection.

It is therefore an object of the present invention to provide methods and devices to aid law enforcement, military, security, emergency medical, and other workers in searching pockets, purses, bags, vehicles, and other hidden areas without the use of hands or fingers to avoid potential contact with contaminated needles, knives, drug paraphernalia, razor blades or other objects that may result in injury.

It is also an object of the present invention to provide methods and apparatus for searching hidden areas without the use of hands or fingers in order to reduce the risk of infection from blood borne pathogens, including hepatitis B, hepatitis C and HIV.

It is also an object of the present invention to provide methods and apparatus that are inserted into hidden areas and then twisted once inside, in order to pry open such areas to allow for visual inspection thereof.

It is also an object of the present invention to provide methods and apparatus including illuminatable flat panels that may be inserted into hidden areas such as pockets or gaps between cushions, and then twisted once inside, in order to pry open such areas to allow for illumination and visual inspection thereof.

Additional objects of the invention will be apparent from the detailed descriptions and the claims herein.

### BRIEF DESCRIPTION OF THE DRAWINGS

FIG. 1 is a front view of an embodiment of the present invention.

FIG. 2 is an end view of an embodiment of the present invention.

FIG. 3 is a series of views showing a method of inserting an embodiment of the present invention into a pocket of an article of clothing, and twisting it to open the pocket for inspection.

FIG. 4 is a front view of an alternative embodiment of the present invention.

FIG. 5 is a front view of an alternative embodiment of the present invention.

FIG. 6 is a front view of an alternative embodiment of the present invention.

FIG. 7 is a front view of an alternative embodiment of the present invention.

FIG. 8 is a front view of an alternative embodiment of the present invention.

FIG. 9 is an end view of an alternative embodiment of the present invention.

### DETAILED DESCRIPTION

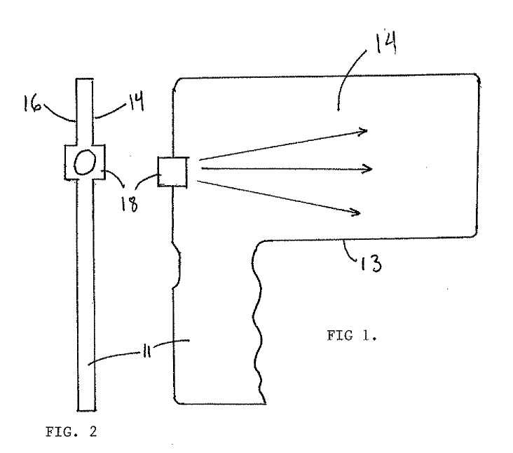

Referring to the drawings wherein like reference numerals designate like or corresponding parts throughout the several views, and referring particularly to FIGS. 1 and 2, it is seen that the illustrated embodiment of the invention includes a handle 11 attached to a thin flat panel 13 having front 14 and rear 16 surfaces. In the side view of FIG. 2, it is seen that the cross section of the illustrated embodiment is very narrow as compared to the wide front 14 and rear 16 surface areas of the panel 13. In the illustrated embodiment, a single light source 18 is provided at the end of panel 13 adjacent to handle 11 for illuminating both surfaces 14, 16 of panel 13. In some embodiments, surfaces 14 and/or 16 may be reflective or mirrored.

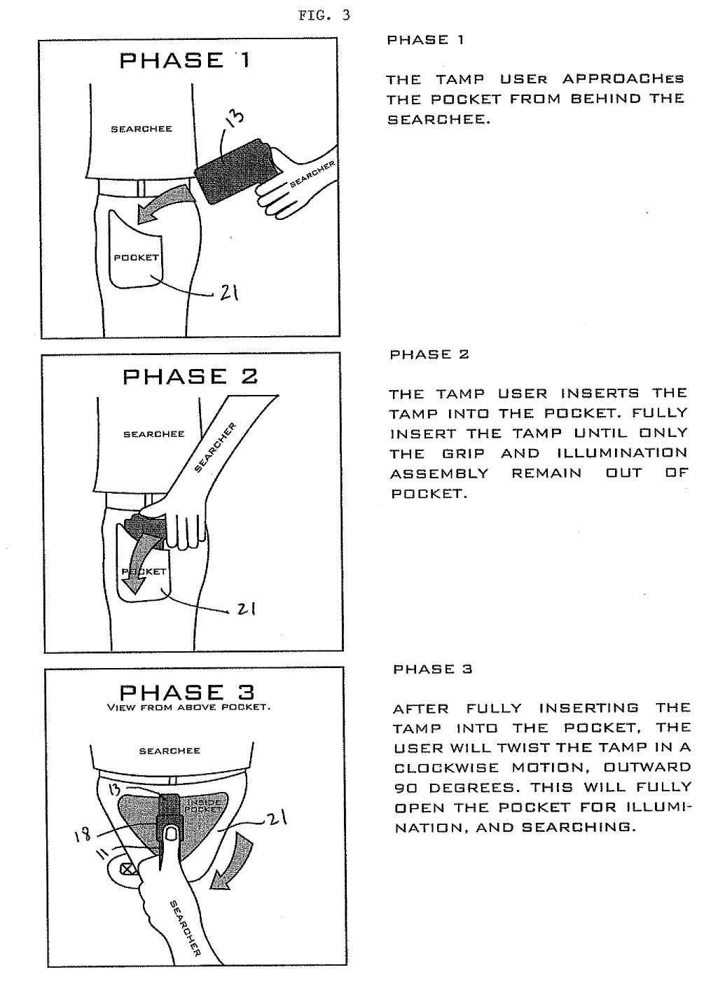

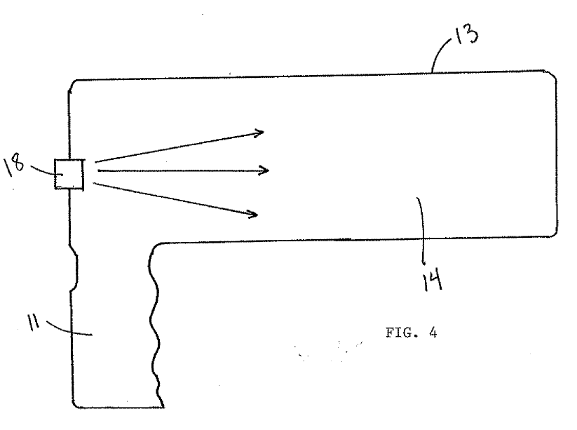

A typical use of an embodiment of the invention (referred to as a “TAMP”) is illustrated in FIG. 3. Initially, an area such as a pocket on a garment of a searchee is identified for inspection (“Phase 1” in the illustration of FIG. 3). Then, flat panel 13 is inserted into the pocket or gap 21, so that the panel is generally parallel to the length of the pocket, as shown in “Phase 2” of FIG. 3. Using the attached handle 11, the user then turns the inserted panel 13 so that it is no longer parallel with the length of the pocket/gap 21. This turn or twist moves the panel as much as 90 degrees, which pries open the pocket or gap, exposing the interior as shown in “Phase 3” of FIG. 3. The light 18 may then be activated, if necessary, to illuminate both surfaces 14, 16 of panel 13, thereby illuminating the interior of the pocket or gap 21 that has been pried open. This allows a visual inspection of this area without the user having to insert a finger or hand, which might otherwise result in a cut or needle prick. Once the objects in the search area have been identified, the inspector may then decide whether or not to insert a hand or finger into the search area to retrieve them.

In some embodiments, such as that shown in FIG. 4, panel 13 may be provided in an extra elongated form, in order to provide access to deeper pockets or gaps. In these embodiments, light source 18 may be made more powerful in order to provide sufficient illumination of a larger area.

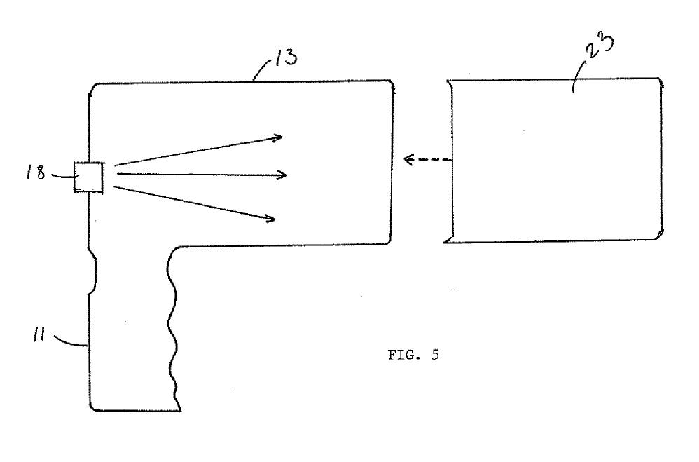

In some embodiments, such as that shown in FIG. 5, a second panel or extension 23 may be provided for temporary attachment to panel 13. The extension 23 may be carried by the user and quickly and easily attached to panel 13 in situations where an elongated probe is needed, such as for deep pockets or gaps. When the deep probing is complete, extension 23 may be detached and stored for use at another time. It is to be appreciated that extension 23 may be provided in any suitable length. In some embodiments, a plurality of alternative extensions 23 having different lengths may be provided, leaving it up to the user to select an extension 23 of appropriate length depending on the circumstances.

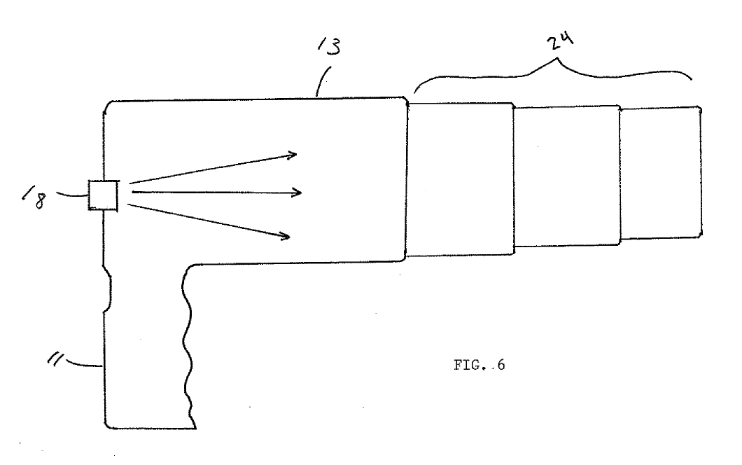

In some embodiments, such as that shown in FIG. 6, a group of telescoping panel extensions 24 may be provided with panel 13. These extensions 24 provide for easy variability in the length of the probe, and may be easily extended to any suitable length depending on the circumstances. Once a length is selected by the user, the telescoping panels 24 may be temporarily locked, clamped or otherwise fixed in place so as not to collapse during use.

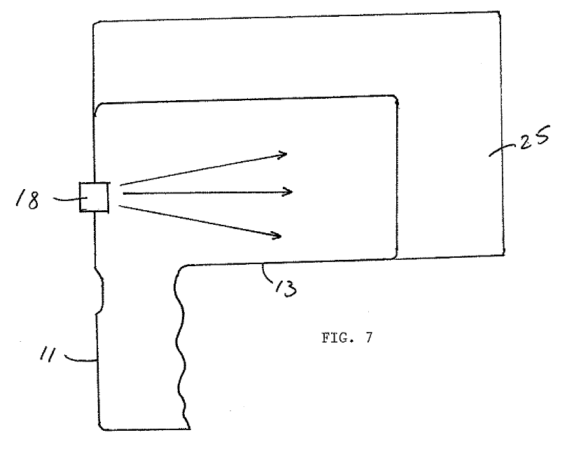

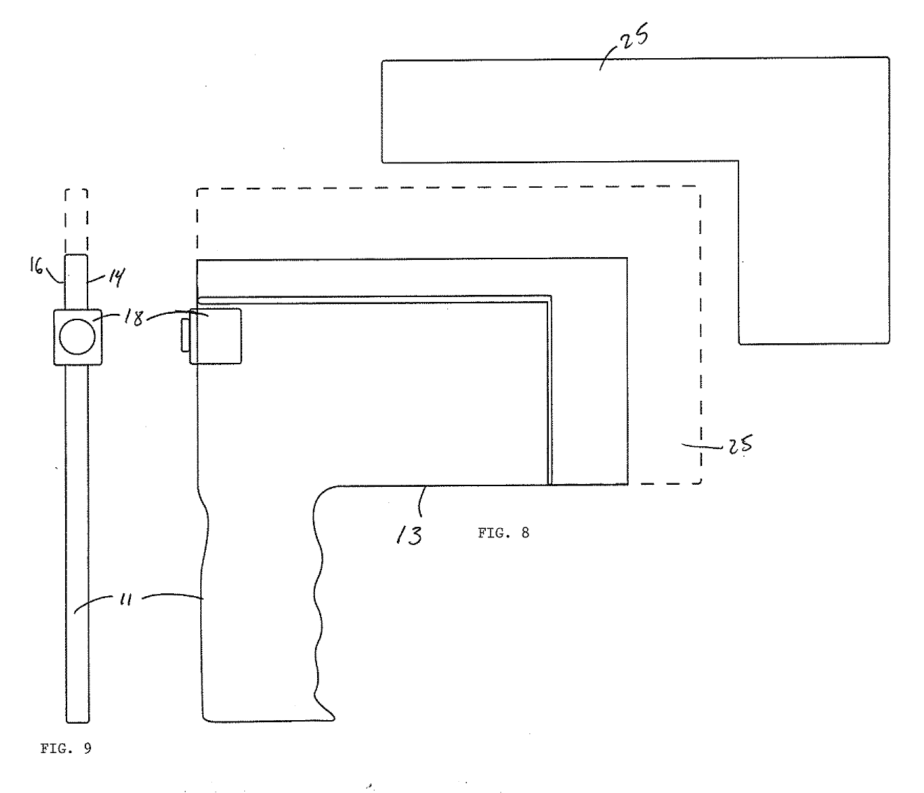

In some embodiments, such as those shown in FIGS. 7-9, a second panel or extension 25 having a generally L-shaped surface may be provided for temporary attachment to panel 13. In these embodiments, extension 25 not only extends the length of panel 13, but also its width. Extension 25 may be carried by the user and quickly and easily attached to panel 13 in situations where a wide, elongated probe is needed, such as for wider, deeper pockets or gaps. When the probing is complete, extension 25 may be detached and stored for use at another time. It is to be appreciated that L-shaped extension 25 may be provided in any suitable length and/or width. In some embodiments, a plurality of alternative extensions 25 having different lengths and/or widths may be provided, leaving it up to the user to select an extension 25 of appropriate length and width, depending on the circumstances.

It is to be understood that variations and modifications of the present invention may be made without departing from the scope thereof, and that different combinations of the elements described herein other than those illustrated are also within the scope hereof. It is also to be understood that the present invention is not to be limited by the specific embodiments disclosed herein, but only in accordance with the appended claims when read in light of the foregoing specification.

What is claimed is:

1. A probe for insertion into a gap for prying open said gap to locate objects hidden therein comprising:
a handle;
a rigid elongated flat panel attached to said handle, said panel having a wide front surface, a wide rear opposite surface, and two narrow sides; and
at least one illuminating member attached to said panel for projecting light along at least one of said front and rear surfaces of said panel.

2. The probe of claim 1 wherein said panel is made of rigid molded plastic.

3. The probe of claim 1 wherein said panel is made of rigid metal.

4. The probe of claim 1 wherein an illuminating member is provided on each of said front and rear surfaces.

5. The probe of claim 1 wherein at least one surface of said panel is mirrored.

6. The probe of claim 1 wherein a plurality of panels are movably attached to said handle for adjusting total probe width.

7. The probe of claim 1 wherein a plurality of panels are telescopingly provided on said flat panel for adjusting total probe length.

8. The probe of claim 1 further comprising a second flat panel for temporary attachment to said first flat panel to extend total probe length.

9. The probe of claim 1 further comprising a second generally L-shaped flat panel for temporary attachment to said first flat panel to extend total probe length and width.

10. A method for locating hidden objects comprising the steps of:
a. inserting a rigid elongated flat panel having a wide front surface and a wide rear opposite surface into an area to be searched, said panel including at least one illuminating member attached thereto for projecting light along said front and rear surfaces;
b. turning said panel as much as ninety degrees to pry open said area
c. detecting objects hidden in said area by activating said illuminating member so that said objects may be illuminated and visualized.

11. The method of claim 10 comprising the further step of temporarily attaching a second flat panel to said first flat panel to extend total probe length.

12. The method of claim 10 comprising the further step of temporarily attaching a second generally L-shaped flat panel to said first flat panel to extend total probe length and width.

13. The method of claim 10 wherein the area to be searched comprises parallel panels of fabric.

14. The method of claim 10 wherein a plurality of panels are movably attached to said flat panel, and comprising the further step of adjusting total probe width prior to said inserting step.

15. The method of claim 10 wherein a plurality of panels are telescopingly provided on said flat panel, and comprising the further step of adjusting total probe length prior to said inserting step.

16. A method for locating objects hidden in a gap comprising the steps of
a. inserting a rigid elongated flat panel having wide front and rear mirrored surfaces into the gap to be searched, said panel including a handle and at least one illuminating member for projecting light along said front and rear surfaces;
b. twisting said panel to pry open said gap;
c. activating said illuminating member; and
d. visually identifying hidden objects illuminated by the light projected from said illuminating member.

17. The method of claim 16 wherein a plurality of panels are movably attached to said flat panel, and comprising the further step of adjusting total probe width prior to said inserting step.

18. The method of claim 16 wherein a plurality of panels are telescopingly provided on said flat panel, and comprising the further step of adjusting total probe length prior to said inserting step.

19. The method of claim 16 comprising the further step of temporarily attaching a second flat panel to said first flat panel to extend total probe length.

20. The method of claim 16 comprising the further step of temporarily attaching a second generally L-shaped flat panel to said first flat panel to extend total probe length and width.
